(19) United States
(12) Patent Application Publication
(10) Pub. No.: US 2014/0068860 A1
(43) Pub. Date: Mar. 13, 2014

(54) HOSPITAL BED WITH BED LEAVING ALARM FUNCTION

(71) Applicant: Boris SHIH, Taipei City (TW)

(72) Inventor: Boris SHIH, Taipei City (TW)

(73) Assignee: CAREMED SUPPLY INC., New Taipei City (TW)

(21) Appl. No.: 13/610,307

(22) Filed: Sep. 11, 2012

(51) Int. Cl. A61G 7/05; G08B 21/22

(52) U.S. Cl. 5/600

(57) ABSTRACT

A hospital bed with bed leaving alarm function includes a bed frame unit, a plurality of support pads mounted on the bed frame unit to together form a bed surface, on which a patient lies, sits or leans; and a plurality of casters. At least one bed leaving sensing unit is provided on a middle section of the bed surface and connected to an external monitoring device. Each bed leaving sensing unit includes a substrate for correspondingly locking to a top of the support pads, and a plurality of sensors spaced on the substrate and electrically connected to the monitoring device. The bed leaving sensing unit provides pressure data to the monitoring device, and the monitoring device emits an alarm when the pressure data indicates the patient is not lying on the bed, so as to prevent the patient from leaving bed alone or carelessly falling off the hospital bed.

### FIELD OF THE INVENTION

The present invention relates to a monitoring system for hospital bed, and more particularly to a hospital bed with bed leaving alarm function.

### BACKGROUND OF THE INVENTION

With the advanced medical science and the largely improved medical care techniques, human beings now have an average life span 3 to 5 years longer than that at ten years ago. However, the extended average life span also means the increased chance of getting ill. While the modern medical science is sufficient to cure a large part of different diseases and save most patients' lives, all patients would have to undergo predetermined medical treatment processes before they are cured of diseases.

Patients suffering some considerably serious or complicated disease are usually confined to bed during medical treatment or observation. Some bedridden patients just have difficulty in leaving bed by themselves. In this case, nurses or other medical persons have to keep watch over the patients' bed leaving state or help them in moving out of bed. All these would largely increase the nurses' or medical persons' work or burden.

According to statistical data from some research centers, the rate of patients died within 30 days increases by 7% when the number of patients under one nurse's care increases by one; the rate of patients died would become higher than 14% when the average number of patients under one nurse's case increases from 4 to 6; and the rate of patients died would even quickly increase to 31% when the average number of patients under one nurse's care increases to 8.

It can be imagined that, in the future society with population aging, the number of bedridden patients and the time of being confined to bed would significantly increase.

Accordingly, the demand for nurses will continue to increase and the work of nurses will become heavier and heavier. These situations result in the problem of insufficient medical persons and nurses encountered by all hospitals, clinics and nursing houses.

For a nurse who has to look after a large number of patients, particularly bedridden patients, it is very possible that some patient carelessly falls off the hospital bed while the nurse is busy in taking care of other patients and not aware of such serious condition to therefore delay important emergency medical treatment to the fallen patient and even cause a tragic event. In view of the drawbacks and inconveniences of the conventional hospital beds in use, it is desirable to develop an improved hospital bed.

### SUMMARY OF THE INVENTION

A primary object of the present invention is to provide a hospital bed with bed leaving alarm function that includes bed leaving sensing units directly mounted on a bed surface thereof to cooperate with an external monitoring device for monitoring and preventing a patient from leaving the bed alone or carelessly falling off the bed.

Another object of the present invention is to provide a hospital bed that includes bed leaving sensing units not being laid in a bed mattress to be directly pressed by a patient, but being laid on support pads below a bed mattress and indirectly pressed by a patient lying on the bed, so as to provide accurate monitoring of a patient's bed leaving state.

A further object of the present invention is to provide a hospital bed that includes bed leaving sensing units laid on support pads within an area corresponding to a patient's hips when the patient lies, sits or leans on the bed, so that the least possible number of bed leaving sensing units is needed for working with an external monitoring device to achieve the effect of monitoring the patient's bed leaving state.

To achieve the above and other objects, the hospital bed with bed leaving alarm function according to a preferred embodiment of the present invention includes a bed frame unit; a plurality of support pads mounted on a top of the bed frame unit to together form a bed surface, on which a patient lies, sits or leans; a plurality of casters mounted to four lower corners of the bed frame unit; at least one bed leaving sensing unit mounted on a middle section of the bed surface; and a monitoring device electrically connected to the at least one bed leaving sensing unit for monitoring pressure data provided by the at least one bed leaving sensing unit and emitting an alarm signal when the pressure data indicates the patient's bed leaving state.

In the present invention, the bed leaving sensing unit includes a substrate for correspondingly locking to a top of the support pads and a plurality of sensors spaced on a top of the substrate; and the sensors are electrically connected to the external monitoring device. In the preferred embodiment, the substrate is a printed circuit board, and the sensors are directly connected to the printed circuit board by way of surface-mount technology (SMT); and the middle section of the bed surface corresponds to an area within which the patient's hips are located when the patient is lying, sitting or leaning on the bed surface.

In the present invention, the bed frame unit includes a bed bottom frame, a bed frame, and a plurality of driving units. The bed bottom frame has a first supporting frame and a second supporting frame; the second supporting frame is connected to and located around an outer side of the first supporting frame, and the casters are mounted to four lower corners of the second supporting frame. The bed frame has a pad supporting frame and two elevating mechanisms. The pad supporting frame has the support pads laid on a top thereof; and the elevating mechanisms respectively have an upper end pivotally connected to an underside of the pad supporting frame and a lower end pivotally connected to the first supporting frame of the bed bottom frame. The driving units are assembled to and located below the pad supporting frame and respectively include an extension arm connected to the elevating mechanisms.

The present invention is characterized by arranging bed leaving sensing units directly on a bed surface of a hospital bed to work with an external monitoring device. The bed leaving sensing units provide pressure data to the monitoring device, and the monitoring device monitors the received pressure data and determines according to the pressure data whether a patient is still safely lying on the hospital bed. The present invention is also characterized by arranging bed leaving sensing units on support pads and below a bed mattress of a hospital bed within an area of the bed generally corresponding to a patient's hips when the patient is lying, sitting or leaning on the bed, so that the bed leaving sensing units are indirectly instead of being directly pressed by the patient. With these arrangements, the least possible number of bed leaving sensing units is needed to work with the monitoring device for accurately monitoring the patient's bed leaving state.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a hospital bed with bed leaving alarm function according to a preferred embodiment of the present invention;

FIG. 2 is a partially exploded perspective view of FIG. 1;

FIG. 3 is perspective view of a bed leaving sensing unit for the hospital bed of the present invention; and

FIG. 4 is a top view of the hospital bed with bed leaving alarm function according to the present invention with a patient lying thereon and monitored via bed leaving sensing units on the hospital bed.

### DETAILED DESCRIPTION OF THE PREFERRED EMBODIMENTS

The present invention will now be described with a preferred embodiment thereof and with reference to the accompanying drawings.

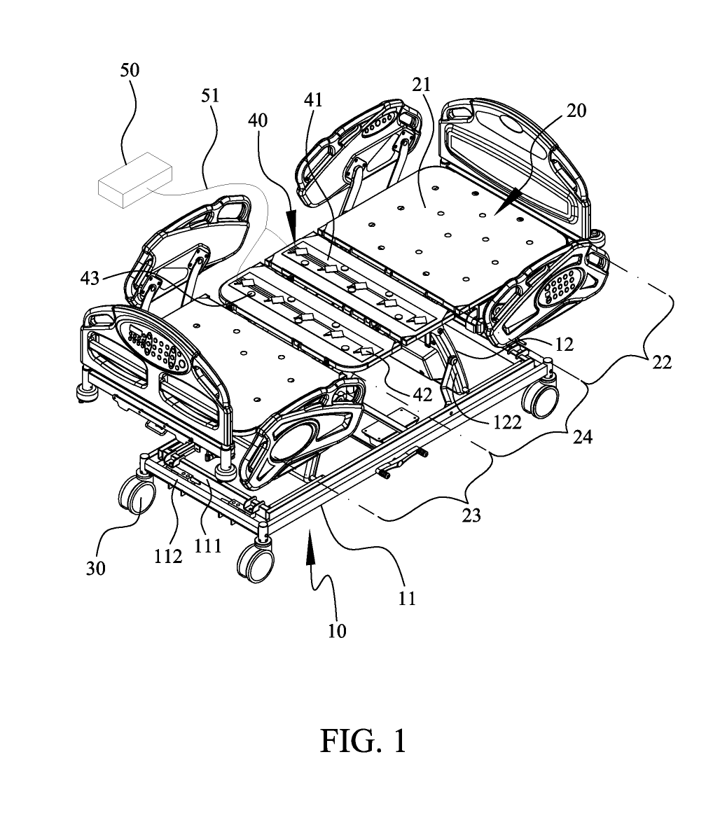

Please refer to FIG. 1. A hospital bed with bed leaving alarm function according to a preferred embodiment of the present invention includes a bed frame unit 10, four support pads 20, four casters 30, two bed leaving sensing units 40, and a monitoring device 50. It is understood the preferred embodiment is only illustrative and not intended to restrict the support pads 20, casters 30, bed leaving sensing units 40 and monitoring device 50 to the illustrated number. That is, the above-mentioned support pads 20, casters 30, bed leaving sensing units 40 and monitoring device 50 may respectively be increased or decreased in number according to different hospital bed structural designs to achieve the optimal bed leaving alarm function.

In the illustrated preferred embodiment, the four support pads 20 are sequentially arranged on a top of the bed frame unit 10 to together form a bed surface 21, over which a patient lies. Two of the four support pads 20 that are located at two opposite ends form an upper-body section 22 and a lower-body section 23 of the bed surface 21, and the other two middle support pads 20 that are located between the upper-body section 22 and the lower-body section 23 together form a middle section 24 of the bed surface 21.

The four casters 30 are mounted to four lower corners of the bed frame unit 10 and are respectively provided with an adjustable brake structure, allowing convenient setting of the hospital bed to a movable state or a braked state.

The two bed leaving sensing units 40 are mounted on the two middle support pads 20 that together form the middle section 24 of the bed surface 21, so as to detect whether the two middle support pads 20 are subjected to a load. In this manner, it is able to effectively detect and monitor at any time whether the patient leaves the bed surface 21.

The monitoring device 50 is connected to the bed leaving sensing units 40 via a signal cable 51, and is able to emit a correspondingly set alarm according to pressure data provided by the bed leaving sensing units 40. When the bed leaving sensing units 40 provide a data showing the existence of pressure thereon, it is indicated the patient is still on the hospital bed and no alarm will be emitted by the monitoring device 50. On the other hand, when the bed leaving sensing units 40 provide a data showing no existence of pressure thereon, it is indicated the patient has left the hospital bed and an alarm, such as an alarm light or an alarm sound, will be emitted by the monitoring device 50 to remind the nurse of such bed leaving state.

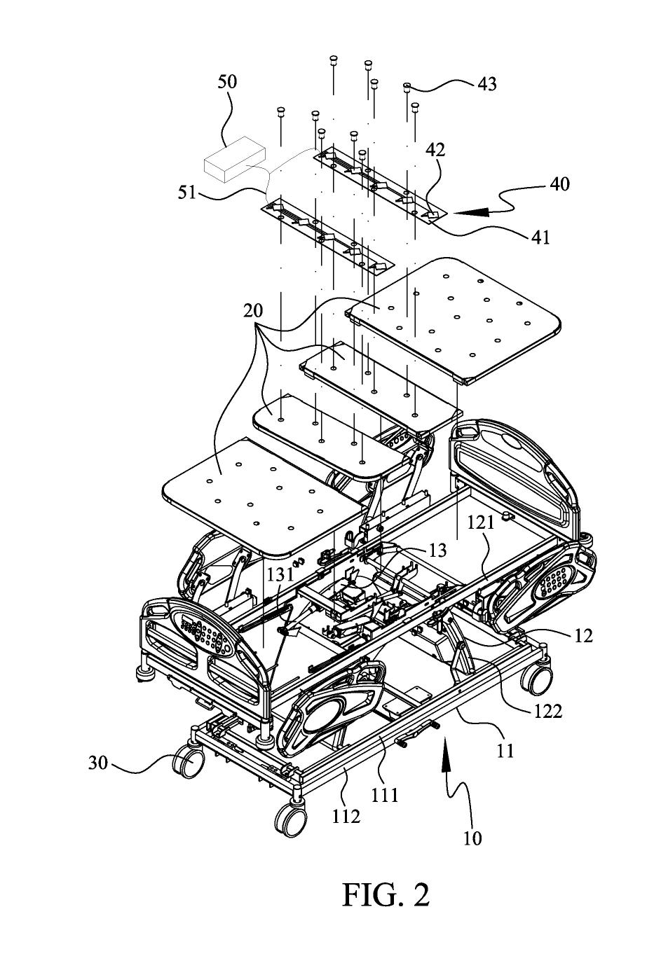

Please refer to FIG. 2. The bed frame unit 10 includes a bed bottom frame 11, a bed frame 12, and two driving units 13. The bed bottom frame 11 includes a first supporting frame 111 in the form of a rectangular frame, and a second supporting frame 112 also in the form of a rectangular frame. The second supporting frame 112 is connected to and located around an outer side of the first supporting frame 111. The four casters 30 are mounted to four lower corners of the second supporting frame 112.

The bed frame 12 includes a pad supporting frame 121 in the form of a rectangular frame, and two adjustable elevating mechanisms 122. The pad supporting frame 121 is laid horizontally for supporting the support pads 20 on a top thereof. The elevating mechanisms 122 respectively have an upper end pivotally connected to an underside of the pad supporting frame 121 and a lower end pivotally connected to an inner side of the first supporting frame 111 of the bed bottom frame 11.

The two driving units 13 are separately assembled to two inner lateral sides of the pad supporting frame 121 and respectively include an extension arm 131. The extension arms 131 of the two driving units 13 are oriented to two opposite directions to connect to the two elevating mechanisms 122. By extending or retracting the two extension arms 131, the two elevating mechanisms 122 are brought to slide synchronously, so that the whole pad supporting frame 121 can be freely adjusted to any desired elevation relative to the bed bottom frame 11.

Again, it is understood the bed frame unit 10 according to the preferred embodiment is only illustrative and not intended to restrict the bed frame unit 10 to the illustrated structural design in any way. That is, for example, the bed frame unit 10 can be otherwise a foldable hospital bed to save the space needed by the hospital bed when it is not in use.

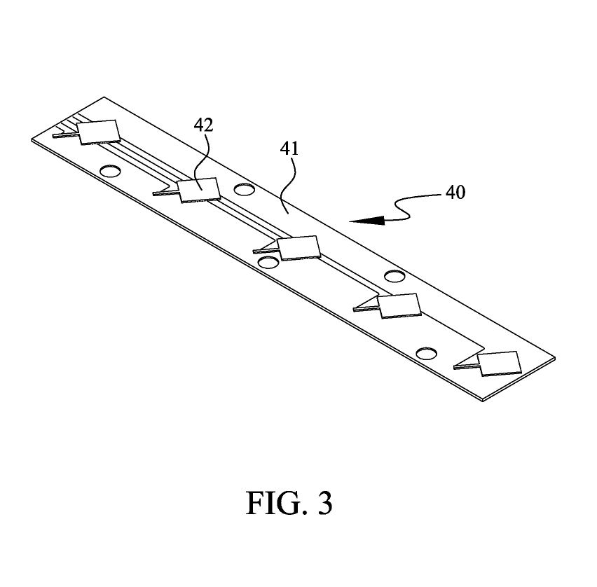

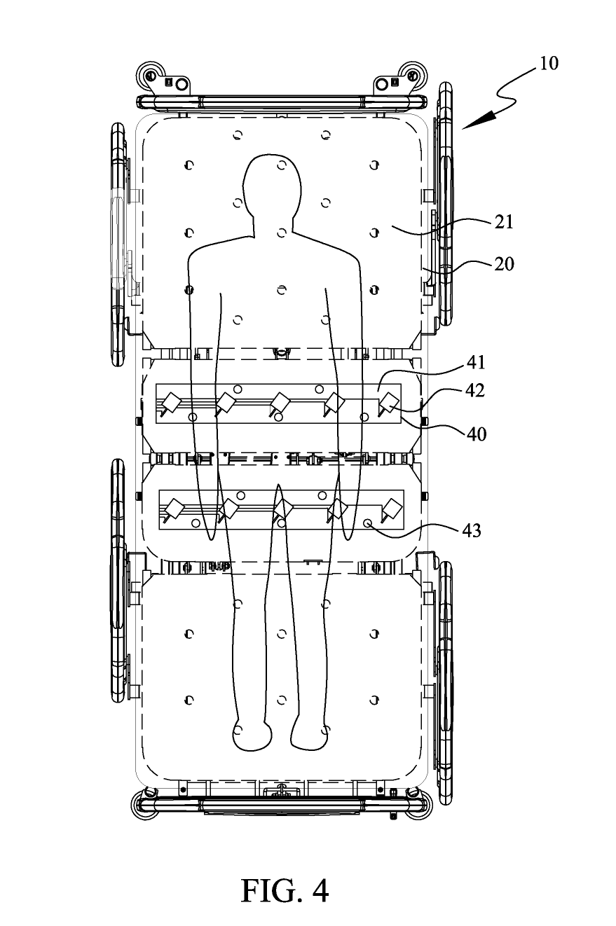

As can be seen in FIG. 3, each of the bed leaving sensing units 40 includes a substrate 41 for correspondingly locking to a top of one middle support pad 20, and a plurality of sensors 42 spaced on a top of the substrate 41. The bed leaving sensing unit 40 is locked to the top of the middle support pad 20 via a plurality of screws 43, as shown in FIGS. 2 and 4; and the sensors 42 are electrically connected to the external monitoring device 50.

In the preferred embodiment, the substrate 41 is configured as a printed circuit board, and the sensors 42 are directly arranged on the printed circuit board by way of surface-mount technology (SMT). In the illustrated preferred embodiment, there are five sensors 42 provided on each of the printed circuit boards for accurately monitoring the patient's lying condition on the hospital bed.

FIG. 4 shows the hospital bed of the present invention with a patient lying on the bed surface 21. When a patient is lying, sitting or leaning on hospital bed, the patient's center of mass is very often located within a central area of the bed, i.e. within an area of the bed being pressed by the patient's hips. Therefore, in the present invention, the bed leaving sensing units 40 are arranged in the middle section 24 of the bed surface 21 that generally corresponds to the patient's hips when the patient lies, sits or leans on the hospital bed. In this manner, the monitoring device 50 can achieve the purpose of monitoring the patient's bed leaving state with the least possible number of bed leaving sensing units 40.

In brief, the present invention is characterized by arranging bed leaving sensing units on the support pads and below the bed mattress of the hospital bed within an area of the bed generally corresponding to a patient's hips when the patient is lying, sitting or leaning on the bed, so that the bed leaving sensing units cooperate with the external monitoring device to monitor whether the patient is currently safely lying on the hospital bed by providing pressure data to the monitoring device.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A hospital bed with bed leaving alarm function, comprising:
a bed frame unit;
a plurality of support pads being mounted on a top of the bed frame unit to together form a bed surface, on which a patient lies;
a plurality of casters being mounted to four lower corners of the bed frame unit;
at least one bed leaving sensing unit mounted on a middle section of the bed surface formed by the support pads; and
a monitoring device being connected to the bed leaving sensing unit for emitting an alarm signal according to a pressure data provided by the bed leaving sensing unit that indicates no existence of pressure on the bed leaving sensing unit.

2. The hospital bed with bed leaving alarm function as claimed in claim 1, wherein the bed leaving sensing unit includes a substrate for correspondingly locking to a top of the support pads and a plurality of sensors spaced on a top of the substrate; and the sensors being electrically connected to the external monitoring device.

3. The hospital bed with bed leaving alarm function as claimed in claim 2, wherein the substrate is a printed circuit board, and the sensors being directly connected to the printed circuit board by way of surface-mount technology (SMT).

4. The hospital bed with bed leaving alarm function as claimed in claim 1, wherein the middle section of the bed surface corresponds to an area within which the patient's hips are located when the patient is lying, sitting or leaning on the bed surface.

5. The hospital bed with bed leaving alarm function as claimed in claim 1, wherein the bed frame unit includes:
a bed bottom frame having a first supporting frame and a second supporting frame;
the second supporting frame being connected to and located around an outer side of the first supporting frame, and the casters being mounted to four lower corners of the second supporting frame; and
a bed frame having a pad supporting frame and two elevating mechanisms; the pad supporting frame having the support pads laid on a top thereof, the elevating mechanisms respectively having an upper end pivotally connected to an underside of the pad supporting frame and a lower end pivotally connected to the first supporting frame of the bed bottom frame.

6. The hospital bed with bed leaving alarm function as claimed in claim 5, wherein the bed frame unit further includes a plurality of driving units; and the driving units being assembled to the underside of the pad supporting frame and respectively including an extension arm connected to the elevating mechanisms.
